(19) United States
(12) Patent Application Publication
(10) Pub. No.: US 2016/0262964 A1
(43) Pub. Date: Sep. 15, 2016

(54) Seat Assembly For A Passenger Conveyance Device

(71) Applicant: Sunrise Medical (US), LLC, Fresno, CA (US)

(72) Inventors: Markus Kramer, Bammental (DE); Thorsten Müller, Muhlhausen-Rettingheim (DE); David Davies, Telford (GB); Gebhard Hofstetter, St. Leon-Rot (DE)

(73) Assignee: Sunrise Medical (US), LLC, Fresno, CA (US)

(21) Appl. No.: 15/069,052

(22) Filed: Mar. 14, 2016

(30) Foreign Application Priority Data
Mar. 13, 2015 (EP) 15159034.6

(51) Int. Cl. A61G 5/10

(52) U.S. Cl. CPC A61G 5/1043; A61G 2005/1045

(57) ABSTRACT

A seat cushion includes a central cushion member between two lateral cushion members. The central cushion member is placed on at least one central seat member. The lateral cushion members are each placed on lateral seat members. At least one of the two lateral seat members is removable from the seat assembly, together with the respective lateral cushion member placed thereon. The removable lateral seat member includes a profile for attaching the lateral cushion member. The removable lateral seat member may also include a through-hole, configured to accept a pivot pin, to provide a pivot connection. A slot, configured to accept a hook, may be provided to provide a latch connection.

### CROSS-REFERENCE TO RELATED APPLICATIONS

This application claims the benefit of European Patent Application No. 15159034, filed Mar. 13, 2015, the disclosure of which is incorporated herein by reference.

### BACKGROUND OF THE INVENTION

This invention relates in general to personal mobility vehicles. In particular, this invention relates to a seat assembly for a passenger conveyance device, especially of a wheelchair or of a scooter, with a seat frame for carrying a seat cushion.

EP 2 540 274 A1 relates to a mounting assembly for mounting an accessory to a frame element of a passenger conveyance device adjacent to a seating area of the passenger conveyance device, wherein the assembly comprises at least one connection element connectable to at least one first connection point of the frame element and to at least one second connection point of the accessory, with the connection element being pivotable relative to the frame element in the first connection point around a first, mainly vertical axis and relative to the accessory in the second connection point around a second axis being parallel to the first axis. Said frame element can be in the form of a strut with slots for receiving bushings provided by the connecting element. Said accessory can be a side plate and/or arm rest.

A seat assembly which can be mounted on various wheelchair bases is known from WO 2006/047341 A2. The seat assembly enables the seat width and backrest width to be adjusted independently of each other. In one embodiment a seat comprises a central main member, such as a pan, and one or more lateral members, such as opposing lateral members or wings, that may be joined to the main member in any suitable manner or fashion. For that purpose the main member is provided with one or more holes and/or slots, and the lateral members are provided with one or more holes and/or slots, which are adapted to selectively align with one or more desired holes or slots in the main member to permit one or more fasteners to pass there through for adjusting the width of the seat. The main member is supported from below by a first seat portion of a center frame, with the first seat portion being slidably adjustable relative to a second seat portion of the center frame to adjusted the seat relative to a back. The lateral members of the seat have a curved outer portion that provide lateral support for the user of the seat assembly.

Side plates provide side support to a passenger and are often used in particular in combination with a one-piece seat cushion. As a more comfortable alternative lateral seat members are provided with a curved outer portion for providing such a side or lateral support. But the alternative has the drawback to impede side transfer of the passenger.

EP 1 374 819 A1 refers to an adjustable foldable planar seat; U.S. Pat. No. 5,123,699 refers to a portable, customized patient support system with detachable bottom back and side cushions; U.S. Pat. No. 2,894,267 refers to a furniture for a physically handicapped person remaining at substantially all the time in a downwardly facing prone position; WO 2005/023163 refers to a device for a width-adjusable wheel chair; and US 2012/0299337 Al refers to an easy access child seat.

It would be desirable to further develop the known seat assembly for a passenger conveyance device to overcome the drawbacks of the prior art.

### SUMMARY OF THE INVENTION

A seat cushion comprises a central cushion member, placed on at least one central seat member, between two lateral cushion members, each placed on a lateral seat member, with at least one of the two lateral seat members being removable from the seat assembly together with the respective lateral cushion member placed thereon, and the at least one removable lateral seat member being provided with at least one profile for the attachment of a lateral cushion member, a through hole for a pivot pin to provide a pivot connection, and/or a slot for a hook to provide a latch connection.

It is preferred according to the invention that the at least one removable, preferably each, lateral seat member is attached to the at least one central seat member via a latch, plug, frictional and/or form connection, which connection is detachable and lockable, and/or the at least one removable, preferably each, lateral seat member is pivotable with respect to the at least one central seat member via a pivot connection.

With the invention it is also proposed that at least one central seat member comprises at least one plate defining a seat plane and two lateral outer portions extending substantially perpendicular to the seat plane, with preferably two seat units forming the central seat member, each seat unit comprising at least one plate and one lateral outer portion, the plates of the two seat units being connectable at different locations for allowing different seat widths. Each seat unit of the central seat member can comprise two plates with a first plate of the one seat unit resting on a second plate of the other seat unit and the first plate of the other seat unit resting on the second plate of the one seat unit, preferably the first plates of both seat units being identical and the second plates of both seat units being identical.

Embodiments of a seat assembly according to the invention can be characterized in that a first part of each latch, plug, frictional and/or form connection, the pivot connection and/or the plug connection is provide by a lateral outer portion of a central seat member, and a mating second part of each latch, plug, frictional and/or form connection, the pivot connection and/or the plug connection is provide by a lateral seat member. The at least one removable, preferably each, lateral seat member can be provided in form of a side rail to which a lateral seat cushion is attachable, in particular via an upper rail profile, and/or the latch connection can be arranged at the front side or the back side of the seat and the pivot connection being arranged at the respective opposite side of the seat, most preferably the frictional connection being arranged between the front side and the back side of the seat.

It is preferred that at least one accessory is detachably mountable to each lateral seat member in addition to a lateral cushion member, with preferably each lateral seat member providing at least two profiles, most preferably three profiles, for the attachment of accessories.

With the invention it is also proposed that the through hole extends substantially perpendicular to the seat plane, the slot extends substantially parallel to the seat plane, and/or the recess extends substantially parallel to the seat plane.

The invention also proposes that each lateral outer portion of the central seat member, to which a lateral seat member is removably attachable, is provided with the pivot pin, the hook and/or an extension for supporting the respective lateral seat member.

Further, it is proposed that each lateral seat member is provided with a chamfered rear end, and/or each lateral seat member comprises a side rail with a front cap.

Still further, it is proposed by the invention that a handle is attached to each removable lateral seat member, most preferably at the outer side of the respective lateral seat member and/or via a rail profile, and a first position of the handle locks a connection between the respective lateral seat member and the central seat member(s) and a second position of the handle opens the connection between the respective lateral seat member and the central seat member(s) such that the respective lateral seat member can be removed together with the respective lateral cushion member attached thereto.

It is preferred that each handle cooperates with a hook provided by the central seat member(s).

The invention also proposes that each lateral outer portion of the central seat member(s) has an L-shaped cross section at least at the front and the rear end of the seat, with one leg of the L-shape being connected to at least one plate of the central seat member(s) and the other leg of the L-shape carrying a respective lateral seat member when attached thereto.

Finally, with the invention it is proposed that the other leg of the L-shape of the lateral outer portion is provided with a pivot pin for a pivot connection with the respective lateral seat member and/or provides an extension on which the respective, lateral seat member is resting when locked to the central seat member(s).

Thus, according to the invention a seat of a seat assembly for example of a wheelchair comprises a three-part seat cushion with shaped side parts in form of lateral cushion members providing a side support to a passenger of the wheelchair, with one of said lateral cushion members being at least removable from the seat assembly in an easy manner to facilitate the transfer of the passenger onto the seat assembly. To realize a side transfer of the passenger a lateral seat member carrying the lateral removable cushion member can be released from the seat assembly by for example unlocking a latch, turning the unit of said lateral seat member with said lateral cushion member outwardly, that is substantially in a horizontal plane around a pivot, and finally detaching the unit by an upward i.e. substantially vertical movement thereof with respect to the remaining seat assembly. However, many alternatives for a respective removal and, thus, the connection between the removable lateral seat member can be realized. It is also possible to have both lateral seat members removably connected to a central seat member. It might be an advantage that the two lateral cushion members are different and/or the two lateral seat members can be arranged differently relative to the central seat member.

Having the option to quickly remove one or both lateral cushion members together with the respective lateral seat member(s), allows for a variety of cushion designs, in addition to lateral side support and easy side transfer.

In addition, further accessories can be attached to each removable lateral seat member such that the respective accessory is removed with the same operation as the lateral cushion member.

Various aspects of this invention will become apparent to those skilled in the art from the following detailed description of the preferred embodiment, when read in light of the accompanying drawings.

### BRIEF DESCRIPTION OF THE DRAWINGS

FIG. 1A is a perspective view of a seat assembly of the invention.

FIG. 1B is a perspective view of the seat assembly of FIG. 1A after unlocking a right lateral seat member with a right lateral cushion member, prior to its detachment.

FIG. 2 is a perspective view of the seat of the seat assembly of FIG. 1A with the seat cushion members being removed and seat frame members being shown.

FIG. 3 is a perspective view of one seat unit of the seat shown in FIG. 2.

FIG. 4A is a top view of a lateral seat member of the seat shown in FIG. 2.

FIG. 4B is a side view of the lateral seat member of FIG. 4A.

FIG. 4C is a cross-section of the lateral seat member shown in FIGS. 4A and 4B.

### DETAILED DESCRIPTION OF THE PREFERRED EMBODIMENT

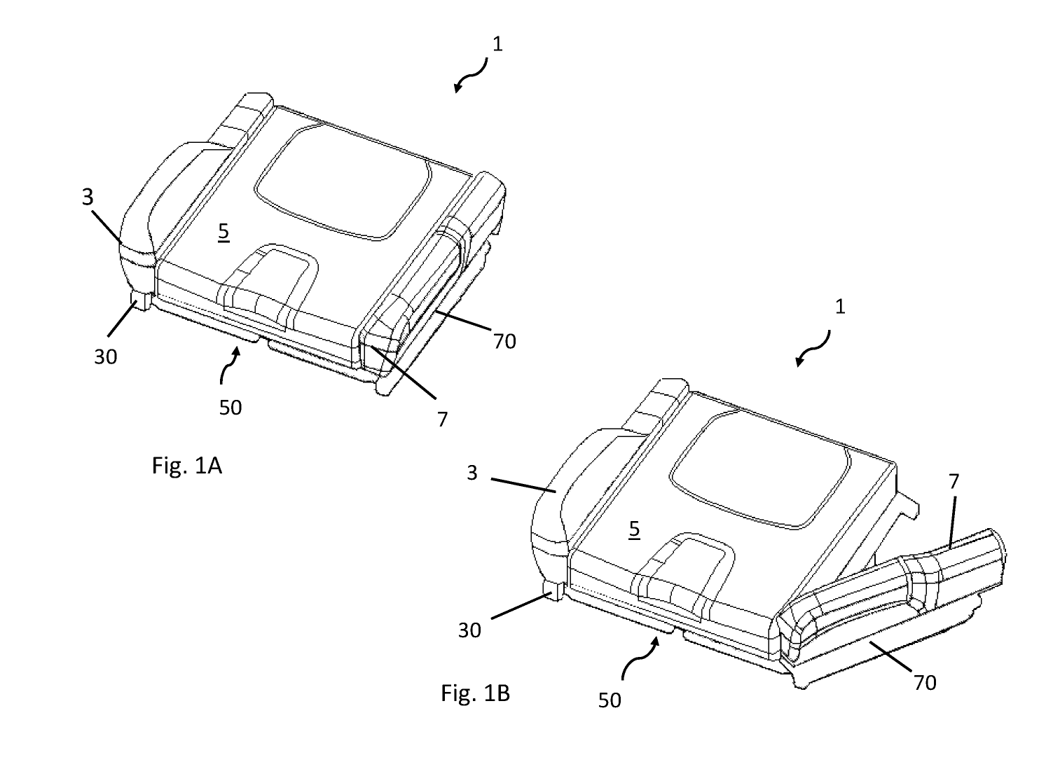

A seat assembly of the invention is in particular suited for a wheelchair. Such a seat assembly 1 is shown in FIG. 1A with a three-part cushion having a lateral cushion member 3 on its left side, a central cushion 5 in the middle and a further lateral cushion member 7 on its right side, with said cushion members 3, 5, 7 being arranged on a seat. Said seat comprises a left lateral seat member 30, a central seat member 50 and a right lateral seat member 70.

The lateral cushion members 3, 7 ensure a lateral support of a passenger (not shown) sitting on the central cushion member 5. In order to facilitate a side transfer of the passenger onto the central cushion member 5, at least one of the lateral cushion members 3, 7 can be removed together with the respective lateral seat member 30 or 70 to which it is attached. For that purpose, in a first step, the connection between the respective lateral seat member, for example the right lateral seat member 70, and the remaining seat assembly 1 has to be unlocked. After such an unlocking, the lateral seat member 70 together with the lateral cushion member 7 can be pivoted outwardly as shown in FIG. 1B. Thereafter, the right lateral seat member 70 together with the right lateral cushion member 7 can be detached from the remaining seat assembly 1 (not shown) such that the passenger can be placed on the central cushion member 5.

As soon as the passenger has taken place on the central cushion member 5, the lateral seat member 70 together with the lateral cushion member 7 can be re-attached to the remaining seat assembly 1 and finally locked in a position as shown in FIG. 1B.

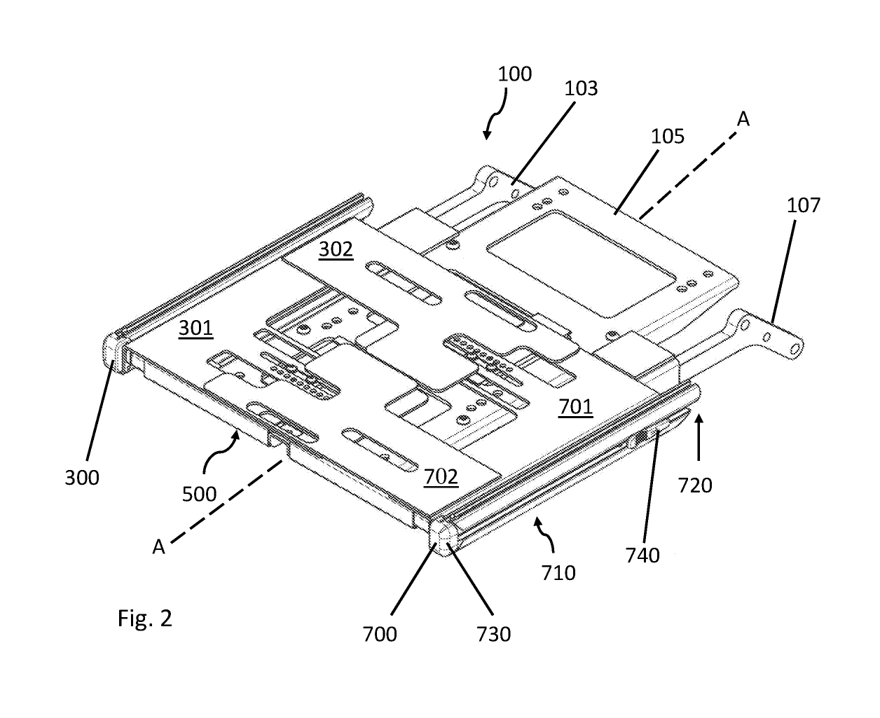

FIG. 2 shows the seat of the seat assembly 1 of FIG. 1A, with the seat cushion being removed, together with a part of a seat frame 100, namely with two lateral frame members 103 and 107 as well as a central frame member 105. The seat frame 100 has a known structure, see e.g. WO 2006/047341 A2 for the principal seat frame structure.

Each lateral seat member is provided by a lateral strut 300, 700, both struts 300, 700 working the same way, with only the strut 700 being discussed in further detail in the following in order to avoid unnecessary repetitions.

The strut 700 is composed of a side rail 710 having a rear end 720 and a front cap 730 at its opposite end. In addition, a handle 740 is attached to the side rail 710.

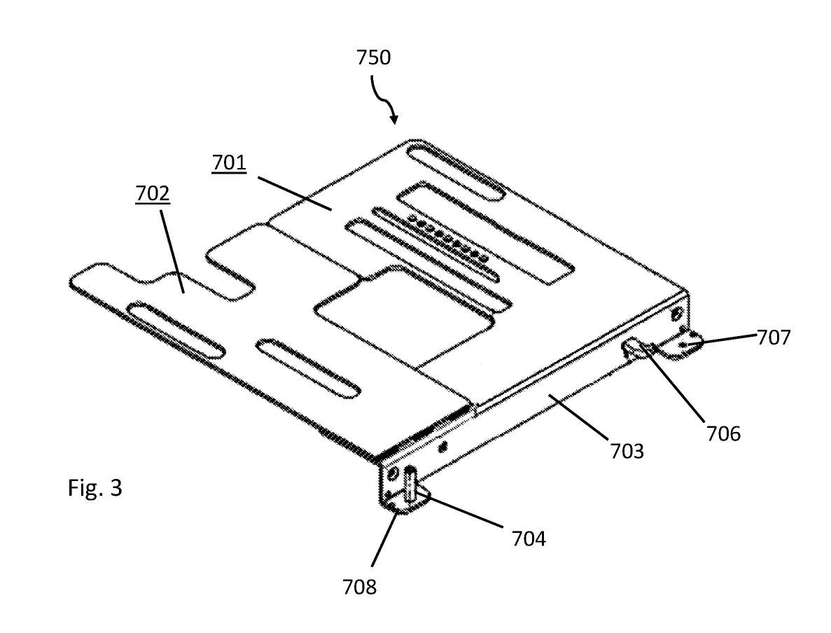

The side rail 710 is attached to a seat unit as shown in FIG. 3. The respective seat unit 750 comprises two seat plates 701, 702 extending in a seat plane to carry the central seat member 5, and an outer portion 703 extending substantially perpendicular to the seat plates 701, 702 and, thus, the seat plane.

The outer portion 703 is provided with a pivot pin 704 on an extension 708 at its front end and a hook 706 as well as an extension 707 at its rear end. At the front as well as rear end the outer portion 703 has an L-shaped cross section due to the extension 707, 708 in order to carry the side rail 710.

The seat assembly 1 comprises an unshown second seat unit, corresponding to the seat unit 750 shown in FIG. 3, to provide the seat shown in FIG. 2. In fact, the second seat unit has an outer portion being mirror symmetrical to the outer portion 703 with respect to the longitudinal seat axis A-A, shown in FIG. 2, and two seat plates 301 and 302, with the seat plate 301 corresponding to the seat plate 701, and the seat plate 302 corresponding to the seat plate 702, such that the seat plates 302 and 702 are resting on the seat plates 301 and 701, respectively. This arrangement allows to attach the seat plate 702 to the seat plate 301 and the seat plate 302 to the seat plate 701 at different positions to adjust the width of the seat and, thus, of the overall seat assembly 1. Depending on the seat width of the seat assembly 1 the central cushion member 5 has to be choosen.

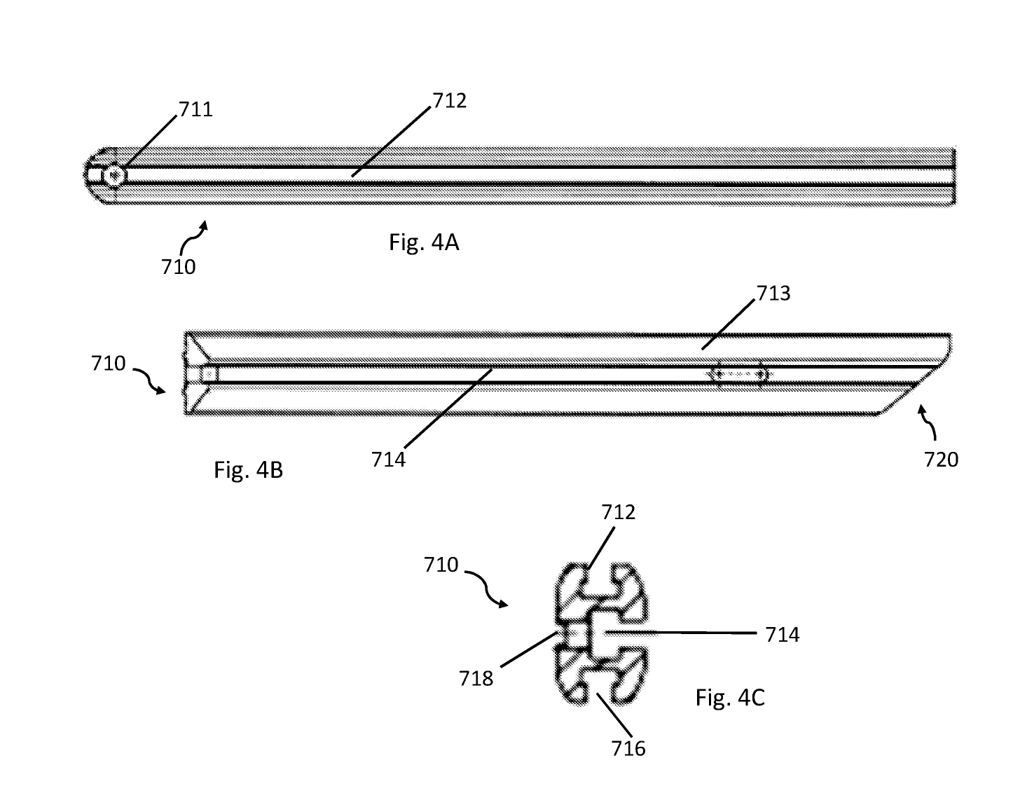

FIGS. 4A to 4C show in detail a side rail 710 to be attached to the outer portion 703 of the unit 750 of the seat.

The side rail 710 has a through hole 711 at its front end such that it can be attached to the pivot pin 704, see FIG. 4A. In addition, a top profile 712 is provided for the attachment of the lateral cushion member 7.

Still further, the side rail 710 is provided with a slot 713 through which at least a part of the hook 706 can extend in order to cooperate with the handle 740, see FIG. 4B. In addition, there is a side profile 714 for the attachment of a further accessory like a control unit (not shown) for the wheelchair.

As can be best seen in FIG. 4C, in addition to the top profile 712 and the side profile 714 there can be a bottom profile 716 for the attachment of a still further accessory, like a holding device (not shown) for a bag for example. The forth side of the side rail 710 provides the connection side 718 for connecting the side rail 710 to the outer portion 703.

The side rail 710 shown in FIGS. 4A to 4C can be attached to the seat unit 750 shown in FIG. 3 by the following steps:
1. Introducing the pivot pin 704 into the through hole 711.
2. Pivoting the side rail 710 in the direction of the outer portion 703, with the rail 710 resting on the extensions 707 and 708.
3. Locking the connection between the unit 750 and the side rail 710 via the handle 740 engaging the hook 706.

In an analog manner a side rail of the left lateral strut 300 together with the left lateral cushion member 3 can be detached from its respective seat unit and thus from the remaining seat assembly 1.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A seat assembly for a passenger conveyance device, especially of a wheelchair or of a scooter, with a seat frame for carrying a seat cushion, wherein the seat cushion comprises:
a central cushion member, placed on at least one central seat member, between two lateral cushion members, each placed on a lateral seat member, with at least one of the two lateral seat members being removable from the seat assembly together with the respective lateral cushion member placed thereon, the at least one removable lateral seat member being provided with at least one profile for the attachment of the respective lateral cushion member, a through hole for a pivot pin to provide a pivot connection, and/or a slot for a hook to provide a latch connection.

2. The seat assembly according to claim 1, wherein the at least one removable, lateral seat member is attached to the at least one central seat member via a latch, plug, frictional and/or form connection, which connection is detachable and lockable, and/or the at least one removable, lateral seat member is pivotable with respect to the at least one central seat member via a pivot connection.

3. The seat assembly according to claim 1, wherein the at least one central seat member comprises at least one plate defining a seat plane and two lateral outer portions extending substantially perpendicular to the seat plane, with two seat units forming the central seat member, each seat unit comprising at least one plate and one lateral outer portion, the plates of the two seat units being connectable at different locations for allowing different seat widths.

4. Seat assembly according to claim 3, wherein each seat unit of the central seat member comprises two plates with a first plate of the one seat unit resting on a second plate of the other seat unit and the first plate of the other seat unit resting on the second plate of the one seat unit, the first plates of both seat units being identical and the second plates of both seat units being identical.

5. Seat assembly according to claim 2, wherein a first part of each latch, plug, frictional and/or form connection, the pivot connection and/or the plug connection is provide by a lateral outer portion of the central seat member, and a mating second part of each latch, plug, frictional and/or form connection, the pivot connection and/or the plug connection is provide by the at least one removable lateral seat member.

6. The seat assembly according to claim 5, wherein the at least one removable, lateral seat member is provided in form of a side rail to which a lateral seat cushion is attachable, in particular via an upper rail profile, and/or the latch connection is arranged at the front side or the back side of the seat and the pivot connection being arranged at the respective opposite side of the seat, the frictional connection being arranged between the front side and the back side of the seat.

7. The seat assembly according to claim 1, wherein at least one accessory is detachably mountable to each lateral seat member in addition to a lateral cushion member, with each lateral seat member providing at least two profiles for the attachment of accessories.

8. The seat assembly according to claim 7, wherein the at least two profiles are three profiles.

9. The seat assembly according to claim 1, wherein the through hole \ extends substantially perpendicular to the seat plane, the slot extends substantially parallel to the seat plane, and/or the recess extends substantially parallel to the seat plane.

10. The seat assembly according to claim 1, wherein each lateral outer portion of the central seat member, to which a lateral seat member is removably attachable, is provided with the pivot pin, the hook, and/or an extension for supporting the respective lateral seat member.

11. The seat assembly according to claim 1, wherein each lateral seat member is provided with a chamfered rear end, and/or each lateral seat member comprises a side rail with a front cap.

12. The seat assembly according to claim 1, wherein a handle is attached to each removable lateral seat member at the outer side of the respective lateral seat member and/or via a rail profile, and a first position of the handle locks a connection between the respective lateral seat member and the central seat member, in particular the two seat units thereof, and a second position of the handle opens the connection between the respective lateral seat member and the central seat member, in particular the two seat units thereof, such that the respective lateral seat unit can be removed together with the respective lateral cushion member attached thereto.

13. The seat assembly according to claim 12, wherein each handle cooperates with a hook provided by the central seat member, in particular the two seat units thereof.

14. The seat assembly according to claim 3, wherein each lateral outer portion of the central seat member, in particular the two seat units thereof, has an L-shaped cross section at least at the front and the rear end of the seat, with one leg of the L-shape being connected to at least one plate of the central seat member, in particular the two seat units thereof, and the other leg of the L-shape carrying a respective lateral seat member when attached thereto.

15. The seat assembly according to claim 14, wherein the other leg of the L-shape of the lateral outer portion is provided with a pivot pin for a pivot connection with the respective lateral seat member and/or provides an extension on which the respective lateral seat member is resting when locked to the central seat member, in particular the two seat units thereof.

16. The seat assembly according to claim 1 wherein the at least one removable lateral seat member is a pair of spaced-apart removable lateral seat members.
